(19) United States
(12) Patent Application Publication
(10) Pub. No.: US 2010/0172602 A1
(43) Pub. Date: Jul. 8, 2010

(54) Draw Tape Bag

(76) Inventors: Hugh J. O'Donnell, Cincinnati, OH (US); Gregory S. Kent, Plainfield, IL (US); Renzy L. Stepp, Algonquin, IL (US)

Correspondence Address: THE CLOROX COMPANY, P.O. BOX 24305, OAKLAND, CA, 94623-1305, US

(21) Appl. No.: 12/602,932

(22) PCT Filed: May 21, 2008
(86) PCT No.: PCT/US08/64316

§ 371 Date: Dec. 3, 2009

Related U.S. Application Data
(60) Provisional application No. 60/944,328, filed on Jun. 15, 2007.

(51) Int. Cl. B65D 33/28; B29C 47/06

(52) U.S. Cl. 383/75; 264/151

(57) ABSTRACT

The draw tape bag may include, a bag body defining a cavity and a rim, the rim defining a mouth to the bag. The bag may include a hem including a passageway, the hem defining at least one opening. The bag may further include at least one multilayer polyolefin draw tape disposed within the hem. The draw tape may include a first skin layer, a second skin layer, and at least one core layer disposed between the skin layers. The draw tape is machine direction oriented. The core layer may be located between the skin layers. The core layer may include high density polyethylene or medium density polyethylene. The skin layers may include low density polyethylene or linear low density polyethylene.

### BACKGROUND

Draw tape bags including polyolefin draw tapes have been used for many years. The draw tapes provide a bag user a means to grip and manipulate a bag as well as providing a means for securing the bag closed. Because the draw tape represents the preferred feature by which a user will grip and manipulate a bag, the draw tape is subject to increased forces.

Prior draw tapes have not possessed the strength necessary to withstand satisfactorily the forces applied to the draw tapes. The known draw tapes often yielded under the stresses applied by a user. Furthermore, many draw tapes typically wrinkle under forces associated with a user lifting a bag. The wrinkling and/or yielding of the draw tape concentrates the weight of the bag on the user's hand thereby making it uncomfortable.

### BRIEF SUMMARY

The draw tape bag may include a machine direction oriented draw tape with improved strength and improved compatibility with heat sealing. In one embodiment, the draw tape bag may comprise a bag body defining a cavity and a rim, the rim defining a mouth to the bag. The bag may comprise a hem including a passageway, the hem defining at least one opening. The bag may further comprise at least one multilayer polyolefin draw tape disposed within the hem. The draw tape may include a first skin layer, a second skin layer, and at least one core layer disposed between the skin layers. The draw tape is machine direction oriented. The core layer may be disposed between the skin layers and the skin layers may be exposed on the surface of the draw tape. The core layer may be comprised of high density polyethylene (HDPE) or medium density polyethylene (MDPE). The HDPE or MDPE of the core layer may be blended with other materials. The skin layers may be comprised of linear low density polyethylene (LLDPE) or low density polyethylene (LDPE). The LLDPE or LDPE of the skin layers may be blended with other materials.

In another embodiment, the bag body may comprise a front panel and a back panel, wherein the front panel and the back panel are joined along a first side seam and a second side seam. The seams may extend from the rim of the bag. The front panel, the back panel, the hem, and the draw tape may be joined in the first seam and second seam by heat sealing, such as, thermal bonding, ultrasonic sealing, hot air bonding, or other techniques.

In another embodiment, a method for producing a draw tape for a draw tape bag may include producing a multilayer film and sending the film through a machine direction orientation assembly. The method for producing a draw tape may further comprise cutting the film into individual draw tapes.

### BRIEF DESCRIPTION OF THE SEVERAL VIEWS OF THE DRAWINGS

FIG. 1 is a perspective view of a draw tape bag.

FIG. 2 is a cross sectional view taken along line 2-2 of the bag of FIG. 1.

FIG. 3 is a cross sectional view taken along line 3-3 of the bag of FIG. 1.

FIG. 4 is partial side view of the draw tape of the bag of FIG. 1.

FIG. 5 is a diagram of a portion of the draw tape film before being sent through the machine direction orientation assembly.

FIG. 6 is a diagram of a portion of the draw tape film after being sent through the machine direction orientation assembly.

FIG. 7 is a schematic diagram of a machine direction orientation assembly.

### DETAILED DESCRIPTION

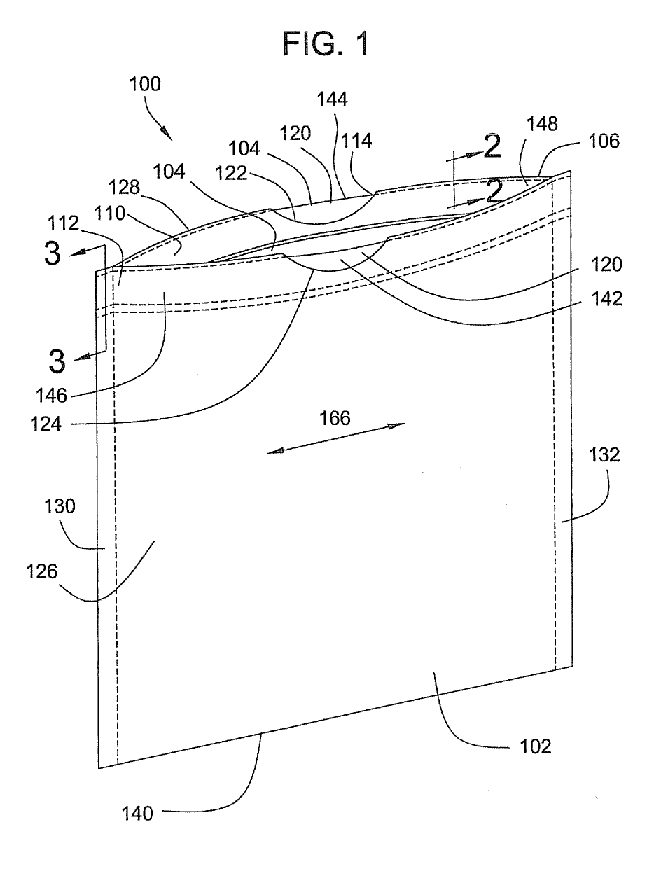

Referring to FIG. 1, a draw tape bag 100 may comprise a bag body 102 defining a cavity 104 and a rim 106, the rim 106 defining a mouth 110 to the bag 100. The bag 100 may include a hem 112 including a passageway 114. The bag 100 may further include at least one multilayer polyolefin draw tape 120 disposed within the passageway 114 of the hem 112. The draw tape 120 is a made from a multilayer film that has been subjected to machine direction orientation (MDO). The hem 112 may include a first opening 122 and a second opening 124 such that the draw tape 120 is accessible to a user at both openings 122, 124. The hem 112 may define the rim 106 so that the draw tape 120 is disposed at the rim 106 of the bag 100.

In one embodiment, the bag body 102 may comprise a front panel 126 and a back panel 128, wherein the front panel 126 and the back panel 128 are joined along a left side seam 130 and a right side seam 132, as shown in FIG. 1. The seams 130, 132 may extend from the rim 106 of the bag 100 to the bottom of the bag 140. The bottom 140 of the bag may be a fold representing where a sheet of material was folded to define the front and back panels 126, 128. The front panel 126, the back panel 128, the hem 112, and the draw tape 120 may be joined in the left side seam 130 and the right side seam 132 by heat sealing, thereby forming the bag body 102 that defines the bag cavity 104 and the bag mouth 110. The draw tape 120 may be comprised of a front piece 142 and a back piece 144 that may be independent pieces sealed at either end in the left and right side seams 130, 132. Likewise, the hem 112 may be comprised of independent front and back sections 146, 148 that are joined at either end at the left and right side seams 130, 132.

The bag body 102 may be comprised of polyethylene, such as, for example, low density polyethylene (LDPE). In other embodiments, the bag body may be made of linear low density polyethylene (LLDPE), medium density polyethylene (MDPE), or high density polyethylene (HDPE).

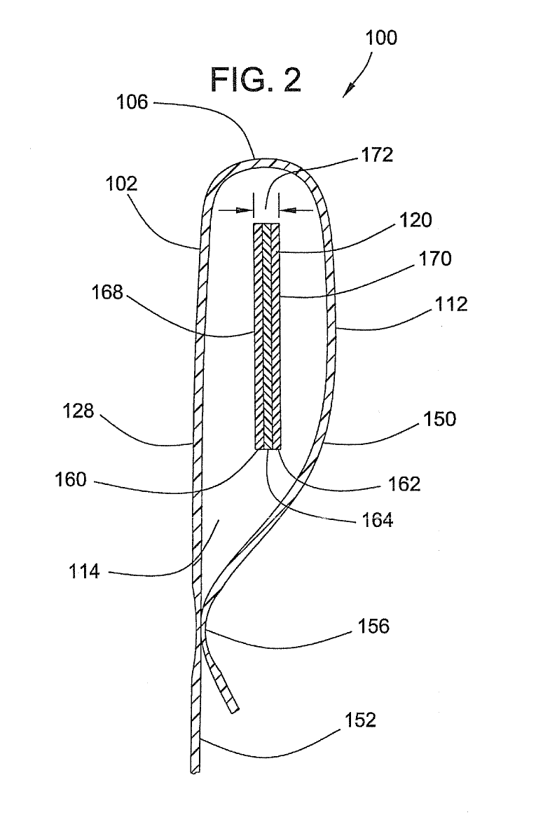

Referring to FIG. 1, the front panel 126 may be a mirror image of the back panel 128. Therefore, only the back panel 128 will be described in detail. Referring to FIG. 2, the hem 112 may be formed by folding over a top piece 150 of material of the back panel 128 and sealing it to the inside surface 152 of the back panel 128 along a first seal 156. The draw tape 120 may be disposed within the passageway 114 of the hem 112.

Referring to FIG. 2, the draw tape may include a first skin layer 160, a second skin layer 162, and at least one core layer 164 disposed between the skin layers 160, 162. The draw tape 120 may be machine direction oriented such that the polymer chains, i.e. the molecules, of the draw tape are oriented in the lengthwise direction of the draw tape 120. Referring to FIG. 1, the machine direction orientation provides greater tensile strength in the draw tape 120 in the lengthwise 166 direction. The lengthwise direction 166 being shown along the length from seam 130 to seam 132. The core layer 164 may be disposed in the center of the draw tape 120, as shown in FIG. 2. The skin layers 160, 162 may be exposed on the surfaces 168, 170 of the draw tape 120, respectively.

Referring to FIG. 2, the core layer 164 of the draw tape 120 may be comprised of HDPE or MDPE. HDPE may have a density equal to or greater than 0.940 g/cc and MDPE may have a density between 0.930 and 0.940 g/cc. In one embodiment, the core layer 164 may be comprised of at least 35% HDPE. In another embodiment, the core layer 164 may be comprised of at least 50% HDPE. In yet another embodiment, the core layer 164 may be comprised of at least 70% HDPE. In another embodiment, the core layer 164 may be comprised of at least 35% MDPE. The HDPE or MDPE of the core layer 164 may be blended with LLDPE, metallocene catalyzed LLDPE (mLLDPE), ultra low density polyethylene (ULDPE), metallocene catalyzed very low density polyethylene (mVLDPE), LDPE, MDPE, ethylene-vinyl acetate (EVA), ethylene methyl acrylate (EMA), Ionomer, polyethylene polypropylene copolymer (PE-co-PP), or PP random copolymer either alone or in combination.

The skin layers 160, 162 may be comprised of LLDPE or LDPE. LDPE may have a density less than 0.930 g/cc and a branched molecular structure. LLDPE may have a density less than 0.930 g/cc and a linear molecular structure. In one embodiment, the skin layers 160, 162 may be comprised of at least 50% LLDPE. In another embodiment, the skin layers 160, 162 may be comprised of at least 60% LLDPE. In another embodiment, the skin layers 160, 162 may be comprised of at least 50% LDPE. The LLDPE or LDPE of the skin layers 160, 162 may be blended with LLDPE, mLLDPE, ULDPE, mVLDPE, LDPE, MDPE, HDPE, EVA, EMA, Ionomer, PE-co-PP, PP random copolymer, or ethylene-propylene-butylene terepolymer either alone or in combination.

Referring to FIG. 2, the core layer 164 may be thicker than either of the skin layers 160, 162. In one embodiment, the skin layers 160, 162 may combine to form 10% to 60% of the thickness 172 of the draw tape 120. The skin layers 160, 162 may be of equal thickness. In other embodiments, the skin layers may be of unequal thickness, such as, one skin layer may be 10% and the other skin layer may be 50% of the thickness 172 of the draw tape 120.

The multilayer MDO draw tape 120 represents an improved draw tape for a draw tape bag because the draw tape may have at least five qualities; improved tensile strength, a high modulus of elasticity, a comfortable grip, good compatibility with heat sealing, and good compatibility with MDO processes. The combination of these qualities exists because, among other reasons, the draw tape 120 may include a core layer 164 of HDPE or MDPE, while the outside surfaces 168, 170 of the draw tape may be comprised of LDPE or LLDPE.

In one embodiment of the MDO draw tape 120 shown in FIG. 2, the core layer 164 may be HDPE and the skin layers 160, 162 may be LLDPE. The draw tape 120 may exhibit excellent tensile strength and a high modulus of elasticity because the core is made of HDPE. The draw tape 120 will therefore prove to be stiff, strong, and unyielding during use. The improved strength and modulus of elasticity of the draw tape 120 makes it possible to have a thinner draw tape which requires less material usage. The draw tape may have a thickness 172 in a first range of 0.0005 inches (0.0127 mm) to 0.004 inches (0.1016 mm), a second range from 0.001 inches (0.0254 mm) to 0.0016 inches (0.0406 mm), and a third range of 0.0012 inches (0.0305 mm) to 0.0014 inches (0.0356 mm). In one embodiment, the draw tape 120 may have a thickness 172 of approximately 0.0012 inches (0.0305 mm).

The draw tape 120 will also prove more comfortable to a user. The high modulus of elasticity of the core layer 164 may prevent the draw tape 120 from wrinkling, banding, or stretching in the hand of a user as the user lifts or manipulates the bag. Accordingly, the draw tape 120 may not concentrate the weight of the bag, via the draw tape 120, on a narrow portion of a user's hand. Such concentration on user's hand may be unpleasant for the user. The draw tape 120 is also more comfortable in the hand of a user because the skin layers 160, 162 are made of LLDPE, which is soft on the hand of a user.

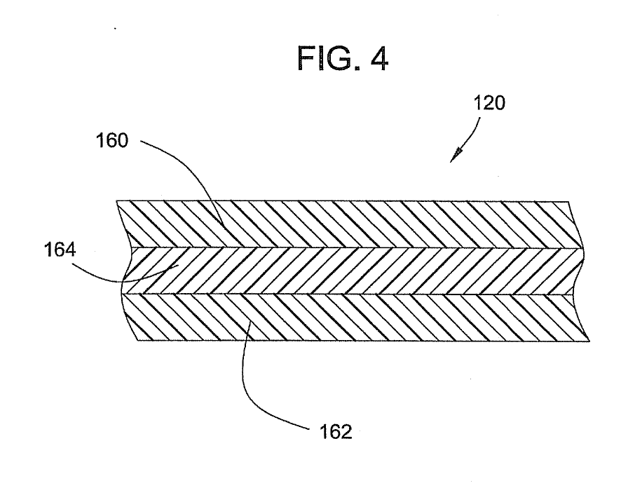

Referring to FIG. 4, the draw tape 120 is compatible with heat sealing. The combination of a HDPE core layer 164 and skin layers 160, 162 of LDPE or LLDPE engenders the qualities described above as well as ensuring that the draw tape 120 may be effectively heat sealed. HDPE films have a higher tensile strength and a higher modulus of elasticity than those of LDPE or LLDPE films. Accordingly, a draw tape including HDPE will have a higher tensile strength and will prove more durable and less likely to fail or plastically deform under user induced forces. The tensile strength of a HDPE film will improve when subject to MDO, thereby resulting in an even stronger draw tape.

However, the seal strength of heat sealed HDPE and LPDE or LLPDE is low because either high distortion in LDPE or LLPDE at the elevated temperatures needed to seal HDPE or low because of the lower temperatures needed to seal LDPE or LLPDE without distortion. HDPE has a higher melting point than lower density polyethylenes, and therefore it tends to shrink less when subjected to the heat applied in a heat sealing process. The melting point of an HDPE film may be 10 to 20 degrees Celsius or more higher than the melting points of an LDPE or LLDPE film. Accordingly, when an HDPE film is heat sealed to a lower density polyethylene film, the lower density film may deform or distort because of the higher temperature. This mismatch in sealing temperatures may result in the lower density polyethylene thinning and weakening when pressed against the stiffer HDPE draw tape during heat sealing.

When heat sealing a draw tape to a bag body, it is therefore desirable that the surfaces being heat sealed together be of polyethylenes with similar densities or melting points. The bag body and the surfaces of the draw tape will have similar melting points and will exhibit similar shrinkage, thereby resulting in a better heat seal. Referring to FIG. 2, the draw tape surfaces 168, 170, which are defined by the skin layers 160, 162, may be comprised of a lower density polyethylene that is similar to the lower density polyethylene of the bag body 102. The skin layers 160, 162 and the bag body 102 may both be LDPE or LLDPE. In other embodiments, the skin layers and bag body may be any combination of lower density ethylenes or polyethylenes with similar densities.

It is also desirable to have a higher density element of a draw tape to resist shrinkage in the draw tape during heat sealing. Referring to FIG. 2, due to the high polymer crystallinity of HDPE, the HDPE core 164 of the draw tape will help mitigate distortion, such as, shrinkage, in the draw tape 120 during heat sealing.

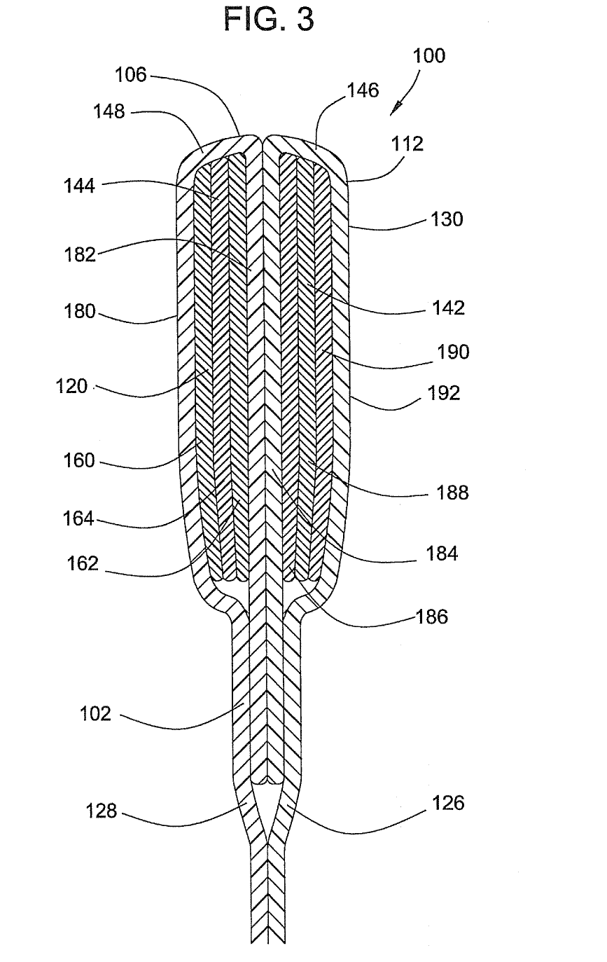

Referring to FIG. 1, the left side seam 130 and the right side 132 seam may be mirror images of each other. Therefore, only the left side seam 130 will be described in detail. Referring to FIG. 3, the left side seam 130 may include the front panel 126, the back panel 128, the hem 112, the draw tape 120, and the bag body 102. The left side seam 130 may include the front and back sections 146, 148 of the hem 112 as well as the front and back pieces 142, 144 of the draw tape 120. Proximate the rim 106, the seam 130 may have ten layers. The seam 130 may include the outside 180 of the back section 148 of the hem 112, the first skin layer 160 of the back piece 144 of the draw tape 120, the core layer 164 of the back piece 144 of the draw tape 120, the second skin layer 162 of the back piece 144 of the draw tape 120, the inside 182 of the back section 148 of the hem 112, the inside 184 of the front section 146 of the hem 112, the second skin layer 186 of the front piece 142 of the draw tape 120, the core layer 188 of the front piece 142 of the draw tape 120, the first skin layer 190 of the front piece 142 of the draw tape 120, and the outside 192 of the front section 146 of the hem 112. The core layers 164, 188 of the two draw tape pieces 144, 142 may be isolated from the other layers during the heat sealing process because they are already joined to their respective skin layers 160, 162, 186, 190 by nature of the multilayer draw tape construction. As such, the layers 180, 160, 162, 182, 184, 186, 190, 192 that will be heat sealed together may all be comprised of predominately the same resin, such as, LLDPE. The seam 130 may therefore experience similar shrinkage among the heat sealed layers. The HDPE cores 164, 188 will help to mitigate overall shrinkage in the draw tape 120 as it is heat sealed to the bag 100. Accordingly, the draw tape 120 is both compatible to heat sealing at the seam and resistant to shrinkage.

Referring to FIG. 2, the draw tape 120 may be compatible with an MDO process. For example, the HDPE of the core layer 164 requires higher drawing temperatures such as 120 C. The LLDPE of the skin layers 160, 162 may require a drawing temperature of 110 degrees Celsius. This 10 degree Celsius difference is relatively large compared to the typical processing window of MDO of 5 to 8 degrees Celsius for optimal conditions. The core layer and the skin layers should be chosen to ensure a compatible MDO processing window.

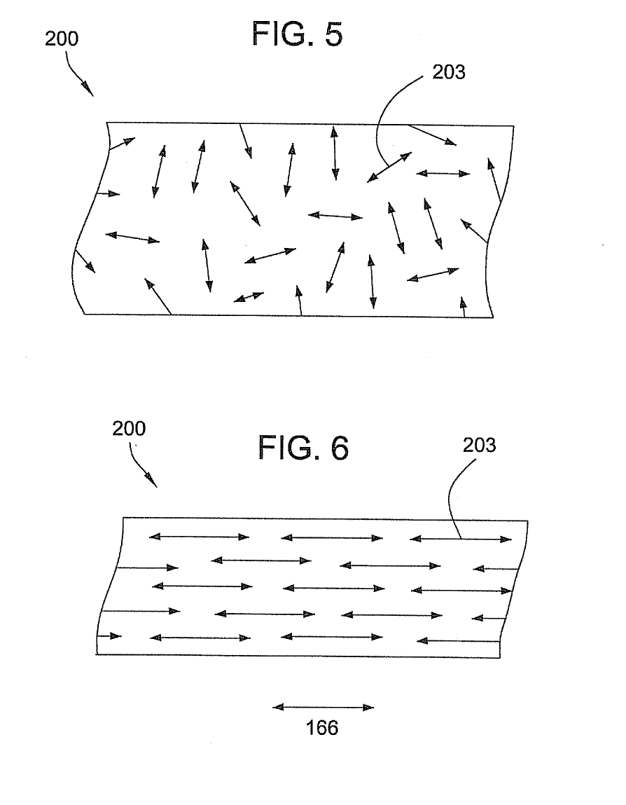

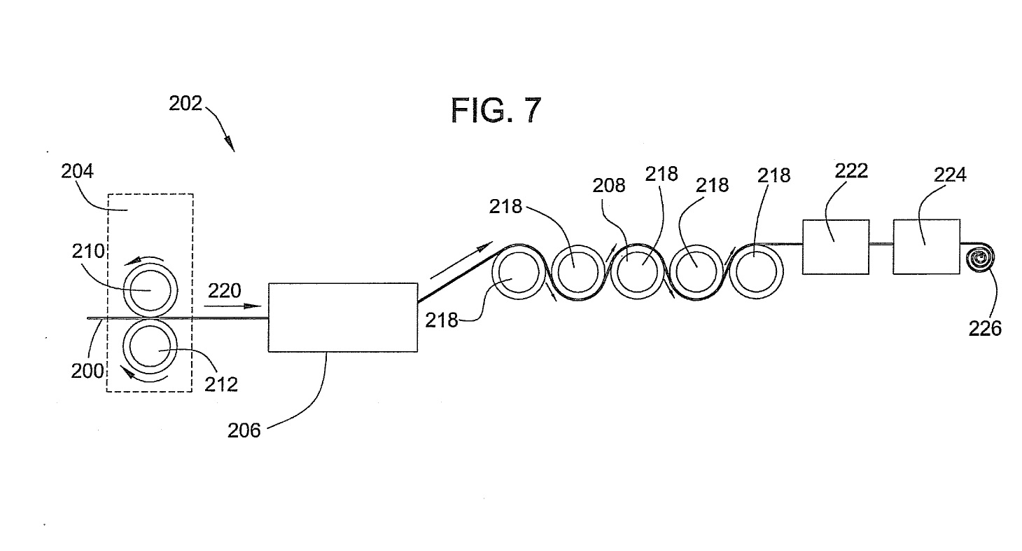

Referring to FIG. 4, the draw tape 120 exhibits excellent tensile strength as a result of the HDPE core 164, but the tensile strength of the entire draw tape 120 may be further improved by subjecting the draw tape to MDO. To improve the tensile strength of the draw tape 120, the film 200 from which the draw tape is constructed may be run through an MDO assembly 202, as shown in FIG. 7, before being assembled into the draw tape bag. Referring to FIG. 5, before a polyolefin film 200 is subjected to MDO, the molecules 203 of the polymer are randomly oriented. As such, the film 200 exhibits similar tensile strength in all directions. Referring to FIG. 6, MDO may be used to orient the molecules 203 of a film 200 in a particular direction. When the molecules 203 are oriented in a particular direction, the tensile strength of the film 200 will be increased in that direction.

Referring to FIG. 1, because the draw tape 120 experiences the greatest forces in the lengthwise direction 166, the multilayer film may be subjected to MDO such that the resulting draw tape 120 will have its molecules oriented in the lengthwise direction 166. In this way, the draw tape 120 may best utilize the increased strength imparted to the film by MDO.

Producing the multilayer MDO draw tape may include several steps. The multilayer film used to make the draw tape may be formed by extruding the molten material through a die or dies to create the film layers. When the layers are in a molten state, the layers are bonded together into a coextruded multilayer film. The multilayer film may include at least three layers representing the first skin layer, the core layer, and the second skin layer of the finished draw tape. The molecules of the multilayer film 200 may be randomly oriented, as shown in FIG. 5. The multilayer film may then be rolled onto a roll to cool or for transport or storage.

Referring to FIG. 7, the solidified film 200 may be subjected to MDO by sending the film through an MDO assembly 202. Any conventional MDO process or assembly may be appropriately used to orientate the draw tape. The MDO assembly 202 may have a draw ratio of at least 2:1. In another embodiment, the MDO assembly 202 may have a draw ratio of between 3:1 and 8:1. The MDO assembly may include a holding unit 204, a heating unit 206, and an orientating unit 208. The film 200 may enter the assembly 202 through the holding unit 204, which allows the film to pass therethrough at a predetermined rate. The holding unit may include two rollers 210, 212. The film 200 next enters the heating unit 206. The heating unit 206 may be an oven. In another embodiment, the heating unit may be a set of heated rollers. In another embodiment, the MDO assembly 202 may not include a heating unit and any or all of the rollers 218 may be heated. As the film 200 is heated, it may become more ductile. From the heating unit 206, the film 200 is fed into the orienting unit 208, which comprises a plurality of rollers 218. Some of the rollers 218 of the orientating unit may run at a rate that is faster than the feed rate of the holding unit 204. Due to the increased ductility of the heated film 200 and the mismatch of rotation between the rollers 218 of orientating unit 208 and the rollers 210, 212 of the holding 204 unit, the film 200 will stretch in the direction 220 of travel of the film 200. As the film 200 is stretched, the molecules of the film 200 may be mono-axially oriented in the direction 220 of travel of the film 200 through the MDO. Upon leaving the MDO assembly 202, the molecules of film 200 may be oriented in a single direction 166, as shown in FIG. 6. After the film has been run through the MDO assembly, the film may be sent through an annealing unit 222. The annealing unit may be a set of heated rollers or may be another device. The annealing temperature is between the orienting temperature and the cooling temperature. In one embodiment, the annealing temperature is closer to the orienting temperature versus the cooling temperature. In another embodiment, the annealing temperature may be within 10 degrees Celsius of the orienting temperature. The film may be sent through a cooling unit 224. The cooling unit may be a set of rollers or may be another device. The film may be rolled onto a roll 226 for transport or storage. The film may then be cut into individual strips with widths consistent with the width of a single draw tape. The draw tapes may be cut from the film such that the molecules of the draw tape will be oriented in the lengthwise direction of the strip. The draw tapes are then assembled into the bags. The MDO process may include some of the features disclosed in U.S. Pat. Nos. 3,214,503 and 3,619,460 which are incorporated herein by reference in their entireties.

In other embodiments, the draw tape may comprise three layers or more. In one embodiment of a draw tape with more than three layers, the core layer is at least 50% HDPE, and at least 60% of one skin layer exposed on the surface is comprised by one or more polyethylenes with a density of 0.940 g/cc or less. Additional layers may be tie layers that are joined to the other layers. In one embodiment, the tie layers may be polyolefin copolymers or terepolymers such as Bynel by Dupont. The tie layers may include some of the features disclosed in US. Patent Publication 2003/0211350 which is incorporated herein by reference in its entirety. For example, the tie layers may comprise a polyolefin selected from the group consisting of syndiotactic PP, EP copolymer, BP copolymer, EPB terpolymer, MDPE, metallocene-catalyzed LLDPE, LDPE, metallocene-catalyzed PE, EVA copolymer, EMA copolymer; EMA copolymer and ionomer, e.g., Surlyn™ ionomer.

Referring to FIG. 4, the composition of first skin layer 160, the second skin layer 162, and the core layer 164 may be comprised of various polyolefin films arranged in various combinations. The core layer 164 and skin layers 160, 162 may include any one of these materials or a blend of any two or more of these materials in any combination or in any percentages that is consistent with the specification.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventor(s) for carrying out the invention. Variations of those preferred embodiments may become apparent to those of ordinary skill in the art upon reading the foregoing description. The inventor(s) expect skilled artisans to employ such variations as appropriate, and the inventor(s) intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A draw tape bag comprising;
a bag body defining a cavity and a rim, the rim defining a mouth to the bag;
a hem including a passageway, the hem defining at least one opening in the hem; and
at least one multilayer polyolefin draw tape disposed within the hem, the draw tape including a first skin layer, a second skin layer, and a core layer disposed between the skin layers, wherein the draw tape is machine direction oriented.

2. The bag of claim 1 wherein the bag body may comprise;
a front panel and a back panel, the front panel and the back panel are joined along a left side seam and a right side seam, the seams extending from the rim of the bag.

3. The bag of claim 2 wherein the front panel, the back panel, the hem, and the draw tape are joined in the left side seam and the right side seam by heat sealing.

4. The bag of claim 1 wherein the core layer includes HDPE.

5. The bag of claim 1 wherein the core layer is comprised of a polyethylene with a density greater than or equal to 0.930 g/cc blended with a material selected from the group consisting of LLDPE, mLLDPE, ULDPE, mVLDPE, LDPE, MDPE, EVA, EMA, Ionomer, PE-co-PP, and PP random copolymer.

6. The bag of claim 1 wherein the skin layers include LDPE.

7. The bag of claim 1 wherein the skin layers include LLDPE.

8. The bag of claim 1 wherein at least one skin layer is comprised of a polyethylene with a density less than 0.930 g/cc blended with a material selected from the group of consisting of LLDPE, mLLDPE, ULDPE, mVLDPE, LDPE, MDPE, HDPE, EVA, EMA, Ionomer, PE-co-PP, PP random copolymer, and ethylene-propylene-butylene terepolymer.

9. The bag of claim 1 wherein the core layer is thicker than either of the skin layers.

10. The bag of claim 1 wherein the draw tape has a thickness in a range of 0.0005 inches (0.0127 mm) to 0.004 inches (0.1016 mm).

11. The bag of claim 1 wherein the melt point of the core layer and the melt point of the skin layers differ by at least 10 degrees Celsius.

12. The bag of claim 1 wherein the draw tape may include tie layers.

13. A multilayer draw tape for a draw tape bag comprising;
a first skin layer;
a second skin layer; and
a core layer;
wherein the draw tape is machine direction oriented.

14. The draw tape of claim 13 wherein the core layer is located between the skin layers.

15. The draw tape of claim 14 wherein the core layer includes HDPE.

16. The draw tape of claim 15 wherein the skin layers include LDPE.

17. The draw tape of claim 16 wherein the skin layers include LLDPE.

18. A method for producing a draw tape for a draw tape bag comprising;
providing a multilayer film by extruding multiple resin layers through a die in a molten state and fusing the layers together into a coextruded multilayer film; and
sending the film through a machine direction orientation assembly having a draw ratio between 3:1 and 8:1.

19. The method of claim 18 further comprising cutting the multilayer film into individual strips with a width consistent with a single draw tape, wherein the length of the draw tape will be aligned with the orientation of oriented molecules of the draw tape.

20. The method of claim 18 further comprising;
hot annealing the film.
